(19) United States
(12) Patent Application Publication
(10) Pub. No.: US 2019/0053475 A1
(43) Pub. Date: Feb. 21, 2019

(54) Internal Folding Fish Dip Net and Using Method Thereof

(71) Applicant: Hangzhou Fufan Industrial Co. Ltd., Hangzhou (CN)

(72) Inventor: Hongjian XU, Hangzhou (CN)

(73) Assignee: Hangzhou Fufan Industrial Co. Ltd., Hangzhou (CN)

(21) Appl. No.: 15/811,694

(22) Filed: Nov. 14, 2017

(30) Foreign Application Priority Data
Aug. 16, 2017 (CN) 201710700989.0

(51) Int. Cl. A01K 77/00; A01K 75/00; A01K 74/00

(52) U.S. Cl. CPC A01K 77/00; A01K 63/02; A01K 74/00; A01K 75/00

(57) ABSTRACT

The present invention discloses an internal folding fish dip net including a net ring connecting piece, a handle, a folding main frame, a net pipe and a locking structure. The folding main frame includes a first folding main frame body and a second folding main frame body, and the locking structure is connected to the handle; the folding main frame further includes a directional shaft sleeve, the directional shaft sleeve is fixed in the first folding main frame body, the second folding main frame body is connected to the directional shaft sleeve in a sleeving mode and rotatably mounted on the directional shaft sleeve, and the handle is mounted in the directional shaft sleeve; a main frame hole is formed in the second folding main frame body, a directional hole is formed in the directional shaft sleeve.

### CROSS REFERENCE TO RELATED APPLICATIONS

This application is based upon and claims priority to Chinese Patent Application No. CN 201710700989.0, filed on Aug. 16, 2017, the entire contents of which are incorporated herein by reference.

### TECHNICAL FIELD OF THE INVENTION

The invention relates to an internal folding fish dip net and a using method thereof, and belongs to the field of fishing gear.

### BACKGROUND OF THE INVENTION

A dip net in the prior art can only be folded and is still large in size after being folded, meanwhile, the dip net is not stable enough in structure after being folded, and negative influences on the safety in use and the service life are caused; for this reason, a dip net which can save more space and is higher in connection strength is urgently to be developed.

### SUMMARY OF THE INVENTION

For overcoming the above defects of the prior art, the invention provides an internal folding fish dip net which is reasonable in structural design, capable of saving more space and more stable. The invention further relates to a using method of the internal folding fish dip net.

According to the technical scheme adopted by the invention for solving the above problems: an internal folding fish dip net comprises a net ring connecting piece, a handle, a folding main frame, a net pipe and a locking structure, wherein the folding main frame comprises a first folding main frame body and a second folding main frame body, the net pipe comprises a first net pipe body and a second net pipe body, the net ring connecting piece comprises a first net ring connecting piece body and a second net ring connecting piece body, the first net pipe body is fixedly connected with the first folding main frame body, the first net ring connecting piece body is fixedly connected with the first net pipe body, the second net pipe body is fixedly connected with the second folding main frame body, the second net ring connecting piece body is fixedly connected with the second net pipe body, the first folding main frame body and the second folding main frame body are rotatably mounted, and the first net ring connecting piece body and the second net ring connecting piece body are rotatably mounted; the locking structure is connected with the handle and used for controlling the rotating state of the first folding main frame body and the second folding main frame body; characterized in that the folding main frame further comprises a directional shaft sleeve, wherein the directional shaft sleeve is fixed in the first folding main frame body, the second folding main frame body is connected to the directional shaft sleeve in a sleeving mode and rotatably mounted on the directional shaft sleeve, and the handle is mounted in the directional shaft sleeve in a push-pull mode; a main frame hole is formed in the second folding main frame body, a directional hole is formed in the directional shaft sleeve, and the main frame hole communicates with the directional hole when the first net pipe body and the second net pipe body are completely stretched; the locking structure limits movement of the handle, the first folding main frame body and the second folding main frame body simultaneously when buckled in the main frame hole and the directional hole simultaneously.

Through relative rotation between the first folding main frame body and the second folding main frame body and relative rotation between the first net ring connecting piece body and the second net ring connecting piece body, the first net pipe body and the second net pipe body rotate relatively to be closed. The first net pipe body and the second net pipe body can be mounted detachably and can also be mounted in an inserted mode or in a fixed mode or in various other modes, the mounting mode just needs to ensure that the first net pipe body can be in linkage with the first folding main frame body and the first net ring connecting piece body and to ensure that the second net pipe body can be in linkage with the second folding main frame body and the second net ring connecting piece. When the locking structure is unlocked, the handle can move front and back and rotate in the folding main frame; when the locking structure and the folding main frame are interlocked, the handle is fixed to the folding main frame and cannot rotate or move front and back, and the first folding main frame body and the second folding main frame body cannot rotate relatively.

The net ring connecting piece of the invention comprises an interlocking mechanism, and the interlocking mechanism is connected with the first net ring connecting piece body or the second net ring connecting piece body, and the interlocking mechanism is used for being interlocked with the locking structure, so that the handle and the net ring connecting piece are connected. The handle can move front and back in the folding main frame, so that the relative positions of the handle and the net ring connecting piece are adjusted, the relative positions of the locking structure and the interlocking mechanism are changed accordingly, and the handle is locked on or unlocked from the net ring connecting piece.

The interlocking mechanism of the invention is a lock head connection axis;

when the first net ring connecting piece body is fixedly connected with the lock head connection axis, the second net ring connecting piece body is rotatably mounted on the lock head connection axis; at the moment, the second net ring connecting piece body can rotate around the lock head connection axis, the second net ring connecting piece body rotates relative to the first net ring connecting piece body accordingly, and thus the first net pipe body and the second net pipe body are switched to be in the unfolded state or in the folded state;

when the second net ring connecting piece body is fixedly connected with the lock head connection axis, the first net ring connecting piece body is rotatably mounted on the lock head connection axis; at the moment, the first net ring connecting piece body can rotate around the lock head connection axis, the first net ring connecting piece body rotates relative to the second net ring connecting piece body accordingly, and thus the first net pipe body and the second net pipe body are switched to be in the unfolded state or in the folded state.

The locking structure of the invention comprises a switch axis main body, a key switch, a key spring and a spring pressing plate, wherein one end of the key spring is connected with the spring pressing plate, the other end of the key spring is connected with the key switch, the spring pressing plate is detachably mounted at the bottom of the switch axis main body, the key spring is mounted in the switch axis main body, the switch axis main body is fixed in the handle, a handle hole is formed in the handle, the key switch enters or comes out of the handle hole, and the key switch simultaneously limits movement of the handle, the second folding main frame body and the first folding main frame body when buckled in the handle hole, the main frame hole and the directional hole simultaneously. The switch axis main body serving as a shell is used for accommodating and mounting the key switch, the key spring and the spring pressing plate; meanwhile, since the spring pressing plate is detachably mounted at the bottom of the switch axis main body, the key switch, the key spring and the spring pressing plate can be integrally mounted in the switch axis main body, integral mounting can still be conducted through the spring pressing plate even if the key spring falls or deviates, mounting and operating do not need to be conducted at a narrow opening accommodating the key spring, and thus mounting and maintaining processes are greatly simplified. The whole locking structure can be accommodated in the handle through the switch axis main body, and the key switch and the handle are integrated accordingly; when the key switch falls into the handle, the handle can rotate and be pushed and pulled freely in the folding main frame; when the key switch is ejected out of the handle hole and simultaneously located in the main frame hole and the directional hole, the movement state of the handle and the folding main frame can be limited by the key switch, the handle cannot be pushed or pulled or rotate in the folding main frame, and the first folding main frame body and the second folding main frame body cannot rotate relatively.

The locking structure of the invention comprises a switch axis main body, a switch tightening piece, a switch spring and a switch pressing plate, wherein one end of the switch spring is connected with the switch tightening piece, the other end of the switch spring is connected with the switch pressing plate, the switch tightening piece, the switch spring and the switch pressing plate are all mounted in the switch axis main body, the switch axis main body is fixedly connected with the handle, the switch tightening piece is used for being interlocked with the interlocking mechanism, and the switch spring stretches and retracts in the push-pull direction of the handle. On the one hand, the switch axis main body can serve as a shell used for mounting the switch tightening piece, the switch spring and the switch pressing plate, and on the other hand, the switch axis main body can be matched with the switch tightening piece and be interlocked with the interlocking mechanism, and thus the handle and the net ring connecting piece are interlocked. Meanwhile, the switch spring is squeezed by the switch tightening piece and applies force to the switch tightening piece reversely so that the switch tightening piece and the switch axis main body can still tightly lock the interlocking mechanism when the internal folding fish dip net is placed vertically, and the interlocking mechanism is prevented from rotating and disengaging from the switch tightening piece and the switch axis main body.

The locking structure of the invention comprises a switch axis main body, a key switch, a key spring, a spring pressing plate, a switch tightening piece, a switch spring and a switch pressing plate, wherein one end of the key spring is connected with the spring pressing plate, the other end of the key spring is connected with the key switch, the spring pressing plate is detachably mounted at the bottom of the switch axis main body, the key spring is mounted in the switch axis main body, the switch axis main body is fixed in the handle, a handle hole is formed in the handle, the key switch enters or comes out of the handle hole, and the key switch limits movement of the handle, the first folding main frame body and the second folding main frame body simultaneously when buckled in the handle hole, the main frame hole and the directional hole simultaneously; one end of the switch spring is connected with the switch tightening piece, the other end of the switch spring is connected with the switch pressing plate, the switch tightening piece, the switch spring and the switch pressing plate are all mounted in the switch axis main body, the switch tightening piece is used for being interlocked with the interlocking mechanism, and the switch spring stretches and retracts in the push-pull direction of the handle; the stretching-retracting direction of the key spring is perpendicular to the stretching-retracting direction of the switch spring. Since the key switch, the key spring and the spring pressing plate are used for locking and unlocking the handle and the folding main frame, the key spring stretches and retracts in the radial direction of the handle; since the switch tightening piece, the switch spring and the switch pressing plate are used for locking and unlocking the handle and the net ring connecting piece, the switch spring stretches and retracts in the push-pull direction of the handle. The two components have independent functions and can be fixed in the handle through two independently-arranged switch axis main bodies, however, the two switch axis main bodies are likely to disengage from the handle under such circumstance. By integrating the two components, higher strength is achieved compared with the way that the two components are arranged independently; meanwhile, production procedures are simplified, and cost is reduced.

Convex ribs are arranged on the directional shaft sleeve of the invention, the directional shaft sleeve is fixed in the first folding main frame body through the convex ribs, and the convex ribs are made of metal or alloy. The first folding main frame body is generally made of plastic, and since the friction force of plastic is quite large, the handle is not prone to rotating. A structure matched with the convex ribs is arranged in the first folding main frame body so that the first folding main frame body and the convex ribs with small friction force can firmly form an integrated structure, the second folding main frame body is made to rotate around the directional shaft sleeve, and the second folding main frame body is made to stably rotate around the first folding main frame body accordingly.

A groove is formed in the bottom of the net pipe of the invention, and the interior of the net pipe is of a hollow structure. The net pipe is generally poor in strength and prone to breaking after being grooved, a baffle plate is formed between the interior of the net pipe and the groove through the hollow structure, high strength of the net pipe can be kept through the baffle plate, the average density of the net pipe is decreased through the hollow interior of the net pipe, the buoyancy force of the net pipe is increased, and thus the dip net is not prone to sinking even if the dip net falls into the water.

The groove of the invention is used for mounting a fishnet, and an opening is formed in the groove and is close to the folding main frame. The opening is used as an inlet for the fishnet to be sleeved into the groove; in the prior art, the folding main frame needs to be detached when the fishnet is mounted, and then the fishnet is sleeved into the groove from the two ends of the net pipe. The fishnet can be sleeved into the groove from the opening so that the fishnet can be mounted and dismounted without detaching the net ring connecting piece, and the mounting and dismounting mode of the fishnet in the prior art is greatly changed.

In the invention, when the opening is formed in the first net pipe body, the opening is 1-5 centimeters away from the first folding main frame body, and when the opening is formed in the second net pipe body, the opening is 1-5 centimeters away from the second folding main frame body. If the distance between the opening and the net ring connecting piece is too large, the fishnet is not prone to being sleeved into the whole groove, and if the distance between the opening and the net ring connecting piece is too small, the fishnet is prone to disengaging from the opening. Taking the two problems into consideration, the distance between the opening and the net ring connecting piece is set to 1-5 centimeters.

In the invention, hollow structures are arranged in the first net pipe body and the second net pipe body correspondingly, waterproof plug pieces are arranged at the two ends of the hollow structure in the first net pipe body and at the two ends of the hollow structure in the second net pipe body respectively, the first net pipe body is connected with the first net ring connecting piece body and the first folding main frame body through the corresponding waterproof plug pieces, and the second net pipe body is connected with the second net ring connecting piece body and the second folding main frame body through the corresponding waterproof plug pieces. The first net pipe body, the first net ring connecting piece body and the first folding main frame body can be produced integrally, the second net pipe body, the second net ring connecting piece body and the second folding main frame body can also be produced integrally, however, by adoption of integral production, cost is high, mold opening is difficult, and strength is poor, and thus the assembling way is adopted. Since the interior of the net pipe is of the hollow structure, under the condition that the internal folding fish dip net falls into the water, water enters the hollow structure to make the dip net sink into the water; by blocking the hollow structure through the waterproof plug pieces, water cannot enter the hollow structure even if the internal folding fish dip net falls into the water, and thus the internal folding fish dip net can float on water permanently.

The interlocking mechanism and the locking structure of the invention are both provided with threads, and when the interlocking mechanism and the locking structure are in the locked state, the interlocking mechanism and the locking structure are connected through the threads. Since the handle is rotatably mounted, the locking structure can be driven to rotate to be firmly connected with the interlocking mechanism.

A tightening opening is formed in the switch axis main body of the invention, the interlocking mechanism comprises a tightening protrusion, the shape of the tightening opening is matched with the shape of the tightening protrusion, the tightening opening is used for locking and unlocking the tightening protrusion, and when the tightening opening locks the tightening protrusion, the tightening protrusion is locked between the tightening opening and the switch tightening piece. The tightening protrusion enters the tightening opening, then the tightening opening and the tightening protrusion are clamped together by rotating the tightening protrusion, and accordingly firm locking can be achieved through the switch tightening piece.

The interior of the handle of the invention is of a hollow structure, the switch axis main body is fixed in the handle, a seal ring connecting piece is arranged at the end, away from the net ring connecting piece, of the switch axis main body, and an O-shaped waterproof ring is connected to the seal ring connecting piece in a sleeving mode and mounted in the handle. Since the interior of the handle is of the hollow structure, large buoyancy force can be generated under the condition that the handle falls into the water, correspondingly, a gap can be generated on the joint of the switch axis main body and the interior of the handle, the gap between the switch axis main body and the interior of the handle can be blocked by connecting the O-shaped waterproof ring to the switch axis main body, water is prevented from entering the handle from the gap between the switch axis main body and the interior of the handle after the handle falls into the water, and thus the handle is prevented from sinking into the water.

In the invention, the tightening opening is formed in the front end of the switch axis main body, a tightening protrusion groove is further formed in the front end of the switch axis main body, and the tightening protrusion groove is arranged obliquely relative to the tightening opening in the rotating direction of the handle; the tightening protrusion is located in the tightening protrusion groove when locked by the tightening opening. The tightening protrusion enters the switch axis main body from the tightening opening and falls into the tightening protrusion groove by rotating the handle, the tightening protrusion is firmly limited in the tightening protrusion groove and cannot rotate freely without human effects, and thus accidental unlocking is avoided.

A using method of the internal folding fish dip net is characterized by comprising the following steps that when the locking structure is buckled in the main frame hole and the directional hole simultaneously, the first net pipe body and the second net pipe body cannot rotate relatively, the handle cannot rotate or be pushed or pulled in the folding frame main body, and the locking structure is unlocked and then disengages from the main frame hole and the directional hole. When the locking structure is buckled in the main frame hole and the directional hole simultaneously, the first net pipe body and the second net pipe body are definitely in the unfolded state, the first net pipe body and the second net pipe body cannot rotate relatively, the handle cannot rotate or be pushed or pulled in the folding main frame, the overall connection state is stable, and the internal folding fish dip net can be used stably. The locking structure is unlocked and then disengages from the main frame hole and the directional hole, the handle can rotate and be pushed and pulled at the moment, the first folding main frame body and the second folding main frame body can also rotate relatively, and the internal folding fish dip net can be folded or be switched to other assembling states.

In the invention, after the locking structure disengages from the main frame hole and the directional hole, the handle is pushed, so that the locking structure and the interlocking mechanism are interlocked, and the handle and the net ring connecting piece are interlocked. After the locking structure disengages from the main frame hole and the directional hole, the handle can be pushed and pulled freely, the locking structure and the interlocking mechanism are matched when the handle is pushed to a certain position, and then the locking structure and the interlocking mechanism can be locked firmly by rotating the handle.

In the invention, the tightening opening is made opposite to the tightening protrusion by pushing the handle, the tightening protrusion enters the tightening opening, then the switch tightening piece is squeezed, and the tightening protrusion is rotated to be buckled in the tightening opening.

In the invention, after the tightening protrusion enters the tightening opening, the tightening protrusion is rotated to fall into the tightening protrusion groove, and the tightening protrusion groove is used for limiting rotation of the tightening protrusion.

In the invention, when the key switch is buckled in the handle hole, the main frame hole and the directional hole simultaneously, the key switch is pressed to fall into the handle hole, and thus the handle can rotate or be pushed and pulled in the folding main frame; when the key switch disengages from the main frame hole and the directional hole, the first net pipe body and the second net pipe body are unfolded to make the main frame hole communicate with the directional hole, the key switch is pressed, then the handle is pushed and pulled or rotated till the key switch is buckled in the handle hole, the main frame hole and the directional hole simultaneously, rotation of the first net pipe body and the second net pipe body is limited, and push-pull and rotation of the handle are limited at the same time.

Compared to the prior art, the handle in the invention can slide and rotate freely in the folding main frame, the switch axis main body is matched with the net ring connecting piece when the handle stretches to the foremost end, the handle is locked after being rotated by a certain angle, and then the handle cannot move front and back any more. In the folding process, the first net pipe body and the second net pipe body are combined along with rotation of a folding frame assembly and the folding main frame. The dip net of the invention is particularly suitable for carps which are large in body form, by adoption of the structural design of the invention, the width of the dip net is decreased to about half of the original width after being dip net is folded, the net handle can stretch deep into the dip net, and thus the size of the dip net is greatly reduced during storage and transportation; meanwhile, the internal folding fish dip net is convenient to operate in use and has the advantages of being stable, firm and reliable in structure and the like.

### BRIEF DESCRIPTION OF THE DRAWINGS

FIG. 1 is a front-view structure diagram of an embodiment of the invention;

FIG. 2 is an exploded structure diagram of the embodiment of the invention;

FIG. 3 is an exploded structure diagram of a net ring connecting piece in the embodiment of the invention;

FIG. 4 is an exploded structure diagram of a folding main frame in the embodiment of the invention;

FIG. 5 is an exploded structure diagram of a locking structure in the embodiment of the invention;

FIG. 6 is an exploded structure diagram of a net pipe in the embodiment of the invention;

FIG. 7 is a solid diagram of a handle in the embodiment of the invention;

FIG. 8 is an enlarged structure diagram of the portion F in FIG. 6;

FIG. 9 is a structure change diagram of an internal folding fish dip net from the folded and collapsed state to the folded and non-collapsed state and to the unfolded service state in the embodiment of the invention;

FIG. 10 is a solid structure diagram of the internal folding fish dip net with the handle not mounted in the embodiment of the invention;

FIG. 11 is another solid structure diagram of the internal folding fish dip net with the handle not mounted in the embodiment of the invention;

FIG. 12 is a solid sectional structure diagram of the net ring connecting piece in the embodiment of the invention;

FIG. 13 is a sectional structure diagram after the handle and the locking structure are mounted in the embodiment of the invention;

FIG. 14 is a top-view structure diagram of the folding main frame in the embodiment of the invention;

FIG. 15 is a solid sectional structure diagram in the folded and collapsed state of the embodiment of the invention; and

FIG. 16 is an enlarged structure diagram of the portion G in FIG. 15.

### DETAILED DESCRIPTION OF THE INVENTION

A further detailed description of the invention is given as follows with accompanying drawings and embodiments, the following embodiments are used for explaining the invention, however, the invention is not limited to the following embodiments.

### Embodiment

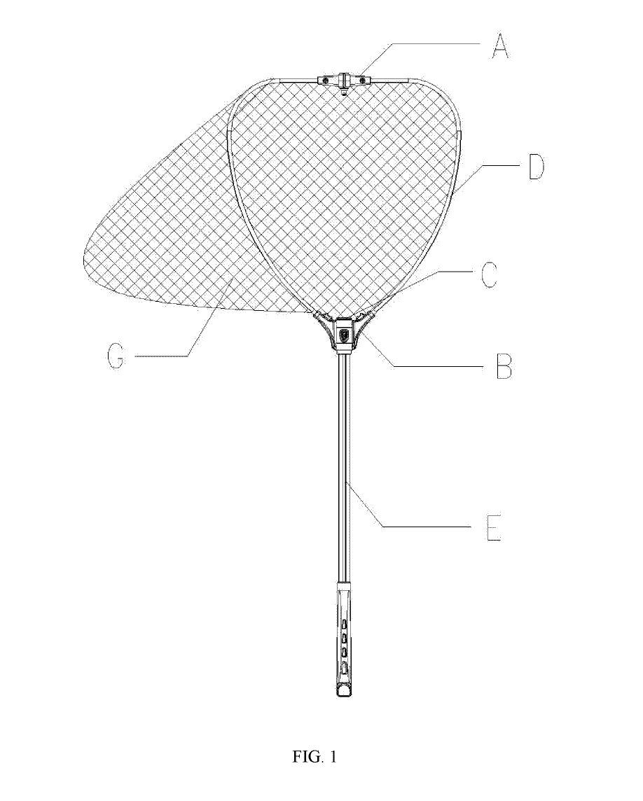

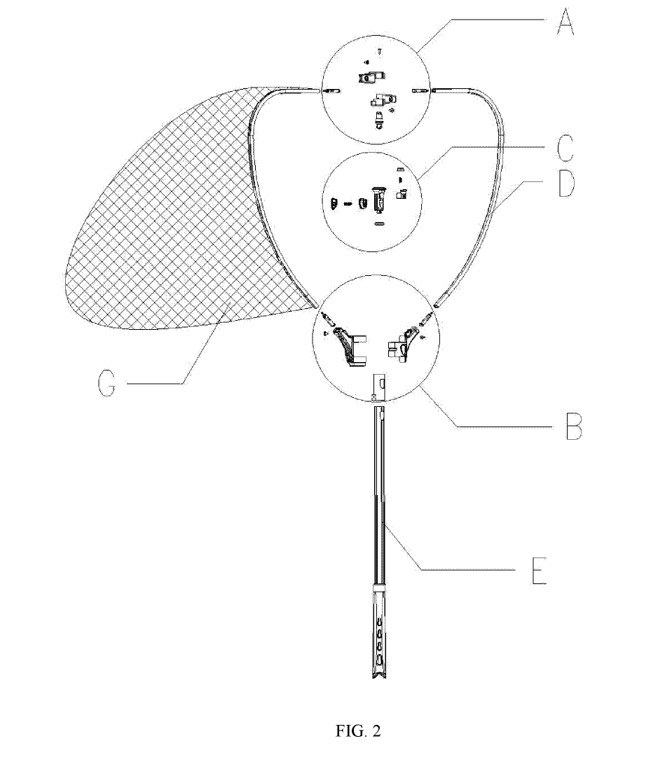

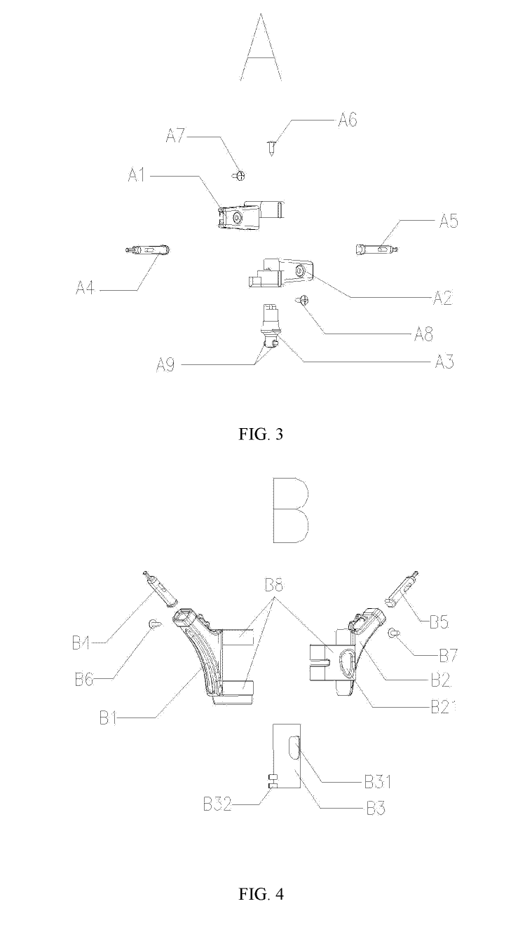

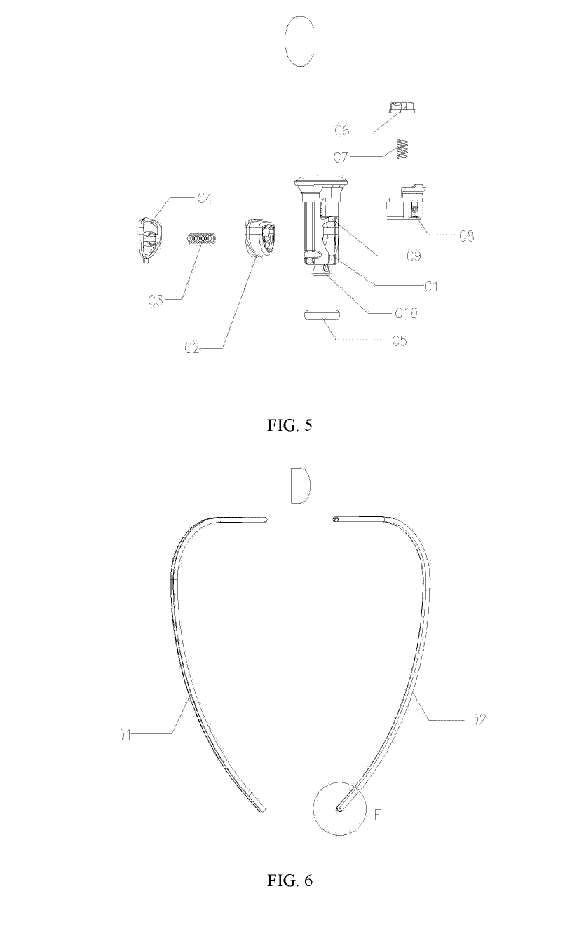

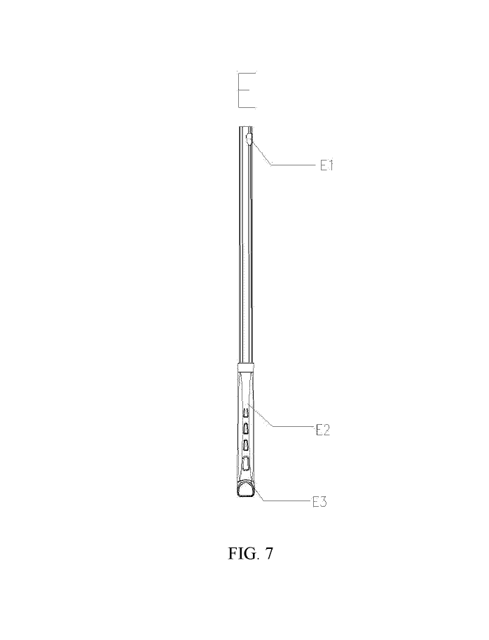

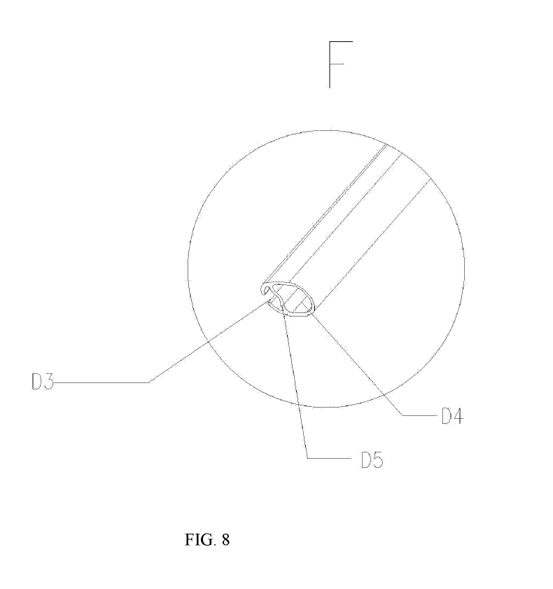

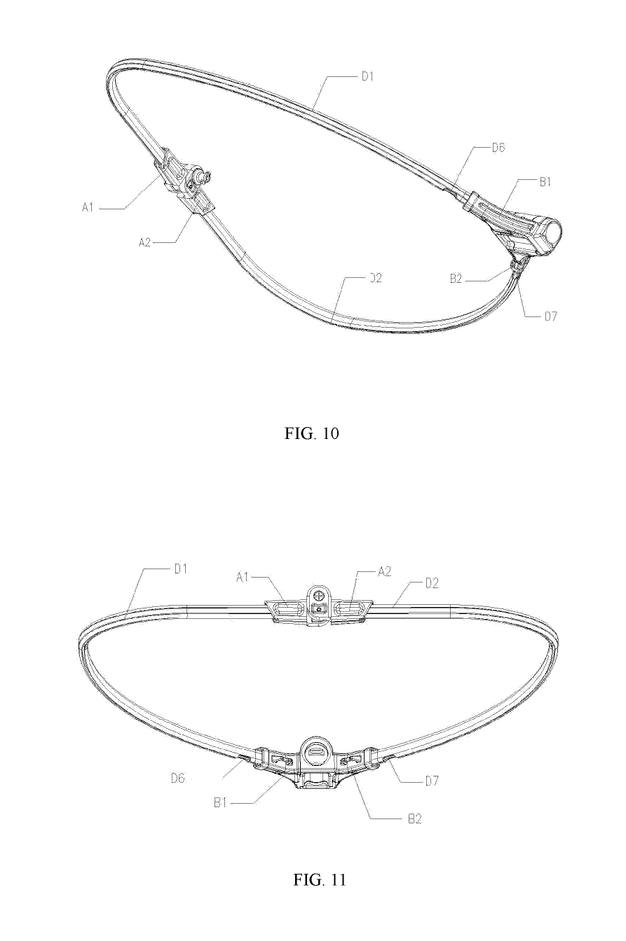

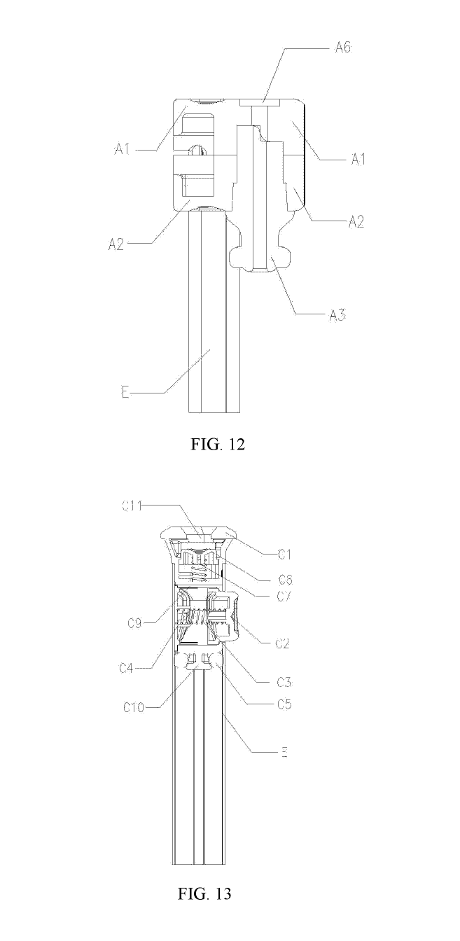

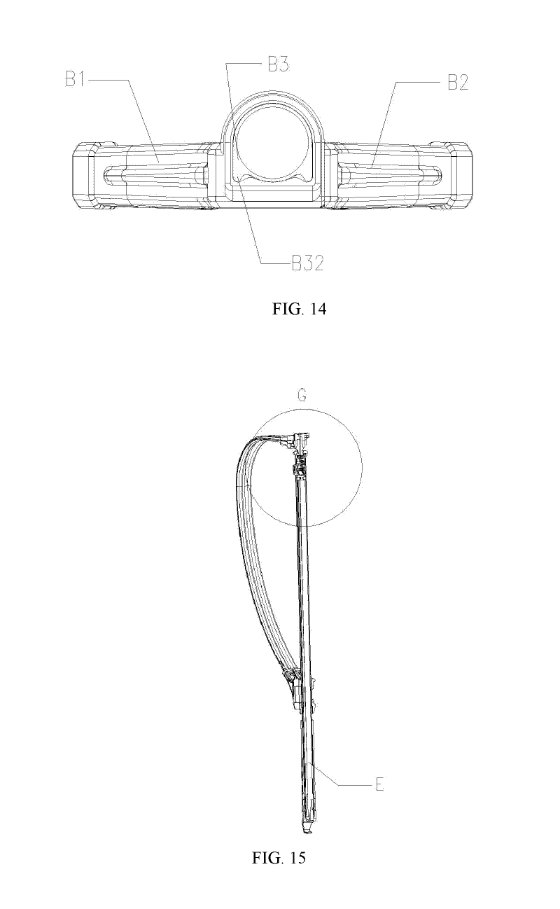

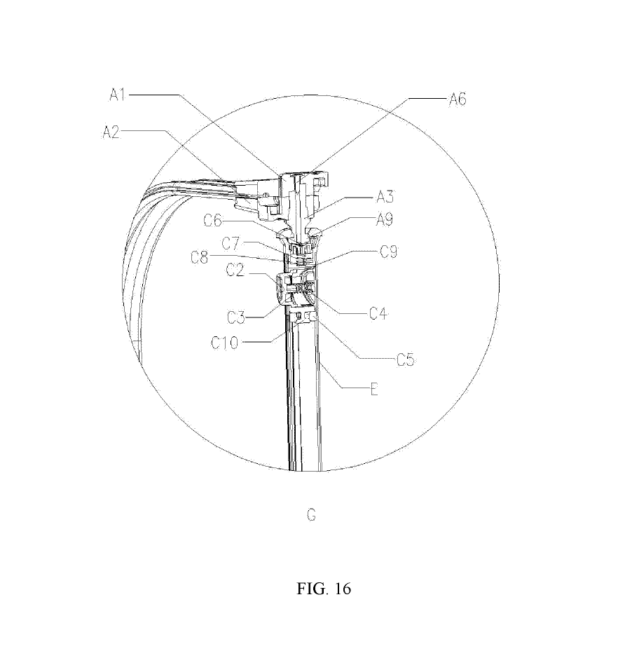

Please see FIGS. 1-16.

An internal folding fish dip net provided by the embodiment comprises a net ring connecting piece A, a handle E, a folding main frame B, a net pipe D and a locking structure C.

Wherein, the folding main frame B comprises a first folding main frame body B1 and a second folding main frame body B2, the net pipe D comprises a first net pipe body D1 and a second net pipe body D2, and the net ring connecting piece A comprises a first net ring connecting piece body A1 and a second net ring connecting piece body A2.

The first net pipe body D1 is fixedly connected with the first folding main frame body B1, and the first net ring connecting piece body A1 is fixedly connected with the first net pipe body D1. The second net pipe body D2 is fixedly connected with the second folding main frame body B2, and the second net ring connecting piece body A2 is fixedly connected with the second net pipe body D2. The first folding main frame body B1 and the second folding main frame body B2 are rotatably mounted, and the first net ring connecting piece body A1 and the second net ring connecting piece body A2 are rotatably mounted. An annular structure is sequentially formed by the first net ring connecting piece body A1, the first net pipe body D1, the first folding main frame body B1, the second folding main frame body B2, the second net pipe body D2 and the second net ring connecting piece body A2, and a fishnet G is mounted in the annular structure.

Preferably, in the embodiment, the upper end of the first net pipe body D1 is fixedly connected with the first net ring connecting piece body A1, and the lower end of the first net pipe body D1 is fixedly connected with the first folding main frame body B1. The first net ring connecting piece body A1, the first net pipe body D1 and the first folding main frame body B1 form the left half part of the internal folding fish dip net. In the embodiment, the first net pipe body D1 can be mounted detachably and can also be mounted in an inserted mode or in a fixed mode or in various other modes, and any mounting mode which ensures that the first net pipe body D1 can be in linkage with the first folding main frame body B1 and the first net ring connecting piece body A1 is available.

Preferably, in the embodiment, the upper end of the second net pipe body D2 is fixedly connected with the second net ring connecting piece body A2, and the lower end of the second net pipe body D2 is fixedly connected with the second folding main frame body B2. The second net ring connecting piece body A2, the second net pipe body D2 and the second folding main frame body B2 form the right half part of the internal folding fish dip net. In the embodiment, the second net pipe body D2 can also be mounted detachably and can also be mounted in an inserted mode or in a fixed mode or in various other modes, and any mounting mode which ensures that the second net pipe body D2 can be in linkage with the second folding main frame body B2 and the second net ring connecting piece body A2 is available.

Since the first folding main frame body B1 and the second folding main frame body B2 can rotate relatively and the first net ring connecting piece body A1 and the second net ring connecting piece A2 can rotate relatively, the left half part of the internal folding fish dip net and the right half part of the internal folding fish dip net can rotate relatively, namely through relative rotation between the first folding main frame body B1 and the second folding main frame body B2 and relative rotation between the first net ring connecting piece body A1 and the second net ring connecting piece body A2, the first net pipe body D1 and the second net pipe body D2 can rotate relatively to be closed, and thus the internal folding fish dip net is switched to be in the unfolded state or the folded state.

In the embodiment, the folding main frame B further comprises a directional shaft sleeve B3, wherein the directional shaft sleeve B3 is fixed in the first folding main frame body B1, and the second folding main frame body B2 is connected to the directional shaft sleeve B3 in a sleeving mode and rotatably mounted on the directional shaft sleeve B3. The second folding main frame body B2 rotates around the directional shaft sleeve B3, and thus the second folding main frame body B2 rotates around the first folding main frame body B1.

According to an alternative scheme of the embodiment, similarly, the directional shaft sleeve B3 can also be fixed in the second folding main frame body B2, and the first folding main frame body B1 is connected to the directional shaft sleeve B3 in a sleeving mode and rotatably mounted on the directional shaft sleeve B3. Since the scheme is substantially the same as the above scheme, a further unnecessary detailed description is not given any more in the embodiment.

Preferably, the first folding main frame body B1 comprises two main frame parts B8, the directional shaft sleeve B3 penetrates through the two main frame parts B8 of the first folding main frame body B1, the second folding main frame body B2 comprises a main frame part B8, the main frame part B8 of the second folding main frame body B2 is located between the two main frame parts B8 of the first folding main frame body B1, and the main body part B8 of the second folding main frame body B2 is mounted on the directional shaft sleeve B3.

Preferably, convex ribs B32 are arranged on the directional shaft sleeve B3, the directional shaft sleeve B3 is fixed in the first folding main frame body B1 through the convex ribs B32, and the convex ribs B32 are made of metal or alloy. The first folding main frame body B1 is generally made of plastic, and since the friction force of plastic is quite large, the handle E is not prone to rotating. A structure matched with the convex ribs B32 is arranged in the first folding main frame body B1 so that the first folding main frame body B1 and the convex ribs B32 with small friction force can firmly form an integrated structure, the second folding main frame body B2 is made to rotate around the directional shaft sleeve B3, and the second folding main frame body B2 is made to stably rotate around the first folding main frame body B1 accordingly.

The handle E is mounted in the directional shaft sleeve B3 in a push-pull mode, a main frame hole B21 is formed in the second folding main frame body B2, a directional hole B31 is formed in the directional shaft sleeve B3, the locking structure C is connected with the handle E, and preferably, the locking structure C is fixed to the front end of the handle E. The locking structure C is used for controlling the rotating state of the first folding main frame body B1 and the second folding main frame body B2. The relative positions of the main frame body B21 and the directional hole B31 are adjusted by rotating the first folding main frame body B1 and the second folding main frame body B2. When the first net pipe body D1 and the second net pipe body D2 are stretched completely, the main frame hole B21 communicates with the directional hole B31. If the locking structure C is simultaneously buckled in the main frame hole B21 and the directional hole B31 at the moment, the locking structure C limits movement of the handle E, the second folding main frame body B2 and the first folding main frame body B1 simultaneously. Correspondingly, the handle E cannot rotate in the directional shaft sleeve B3, the first folding main frame body B1 and the second folding main frame body B2 and cannot stretch or retract under the effect of the locking structure C, and the internal folding fish dip net is in a stable operation and connection state at the moment and can be used stably.

When the locking structure C is unlocked, the handle E can move front and back and rotate in the folding main frame B.

Preferably, the net ring connecting piece A comprises an interlocking mechanism, and the interlocking mechanism is connected with the first net ring connecting piece body A1 or the second net ring connecting piece body A2. The interlocking mechanism is used for being interlocked with the locking structure C, and thus the handle E and the net ring connecting piece A are connected.

When the locking structure C disengages from the main frame hole B21 and the directional hole B31, the handle E can move front and back in the folding main frame B, so that the relative positions of the handle E and the net ring connecting piece A are adjusted, and the relative positions of the locking structure C and the interlocking mechanism are changed accordingly. Meanwhile, the locking structure C can also be driven to rotate through rotation of the handle E. The handle E can be locked on or unlocked from the net ring connecting piece A through push-pull and rotation of the locking structure C. When the locking structure C and the interlocking mechanism are interlocked, the handle E and the net ring connecting piece A are also interlocked; when the locking structure C and interlocking mechanism are unlocked, the handle E and the net ring connecting piece A are also unlocked.

Preferably, the interlocking mechanism is a lock head connection axis A3.

When the first net ring connecting piece body A1 is fixedly connected with the lock head connection axis A3, the second net ring connecting piece body A2 is rotatably mounted on the lock head connection axis A3. At the moment, the second net ring connecting piece body A2 can rotate around the lock head connection axis A3, the second net ring connecting piece body A2 rotates relative to the first net ring connecting piece body A1 accordingly, and thus the first net pipe body D1 and the second net pipe body D2 are switched to be in the unfolded state or in the folded state;

when the second net ring connecting piece body A2 is fixedly connected with the lock head connection axis A3, the first net ring connecting piece body A1 is rotatably mounted on the lock head connection axis A3. At the moment, the first net ring connecting piece body A1 can rotate around the lock head connection axis A3, the first net ring connecting piece body A1 rotates relative to the second net ring connecting piece body A2 accordingly, and thus the first net pipe body D1 and the second net pipe body D2 are switched to be in the unfolded state or in the folded state.

The scheme that the first net ring connecting piece body A1 is fixedly connected with the lock head connection axis A3 and the second net ring connecting piece body A2 is rotatably mounted on the lock head connection axis A3 is substantially identical with the scheme that the second net ring connecting piece body A2 is fixedly connected with the lock head connection axis A3 and the first net ring connecting piece body A1 is rotatably mounted on the lock head connection axis A3, and thus for a brief and clear illustration, only the connection mode that the first net ring connecting piece body A1 is fixedly connected with the lock head connection axis A3 and the second net ring connecting piece body A2 is rotatably mounted on the lock head connection axis A3 is further described in the embodiment. Meanwhile, the first net ring connecting piece body A1 is fixed to the lock head connection axis A3 through a center self-tapping screw A6.

According to one specific execution mode of the interlocking mechanism and the locking structure C, the interlocking mechanism and the locking structure C can be both provided with threads. When the interlocking mechanism and the locking structure C are in the locked state, the interlocking mechanism and the locking structure C are connected through the threads. Since the handle E is rotatably mounted, the locking structure C can be driven to rotate, and the thread on the locking structure C is firmly connected with the thread on the interlocking mechanism. Since the scheme is simple, a specific detailed description of the scheme is not given any more in the embodiment, and those skilled in the field can create design freely according to actual requirements.

Correspondingly, the locking structure C preferably comprises a switch axis main body C1 in the embodiment.

Preferably, the switch axis main body C1 is fixed in the handle E.

Preferably, the handle E is in the shape of a cylindrical rod and is selectively made of aluminum alloy. Since aluminum alloy is light, the handle E does not sink immediately after falling into the water.

According to a preferred scheme for controlling the lock state of the handle E and the folding main frame B, the locking structure C comprises a key switch C2, a key spring C3 and a spring pressing plate C4 in the embodiment.

One end of the key spring C3 is connected with the spring pressing plate C4, the other end of the key spring C3 is connected with the key switch C2, the spring pressing plate C4 is detachably mounted at the bottom of the switch axis main body C1, the key spring C3 is mounted in the switch axis main body C1, a handle hole E1 is formed in the handle E, and the key switch C2 enters or comes out of the handle hole E1 through the key spring C3, namely the key switch C2 is ejected out of or enters the handle hole E1 in the radial direction of the handle E.

Preferably, the key switch C2, the key spring C3 and the spring pressing plate C4 are mounted on the rear portion of the switch axis main body C1, and the key spring C3 stretches and retracts in the radial direction of the handle E.

When the key switch C2 is buckled in the main frame hole B21, rotation of the second folding main frame body B2 is limited by the key switch C2. When the key switch C2 is buckled in the directional hole B31, rotation of the first folding main frame body B1 is limited by the key switch C2. When the key switch C2 is simultaneously buckled in the handle hole E1, the main frame hole B21 and the directional hole B31, movement of the handle E, the second folding main frame body B2 and the first folding main frame body B1 is limited by the key switch C2 simultaneously.

The switch axis main body C1 serving as a shell is used for accommodating and mounting the key switch C2, the key spring C3 and the spring pressing plate C4; meanwhile, since the spring pressing plate C4 is detachably mounted at the bottom of the switch axis main body C1, the key switch C2, the key spring C3 and the spring pressing plate C4 can be integrally mounted in the switch axis main body C1, integral mounting can still be conducted through the spring pressing plate C4 even if the key spring C3 falls or deviates, mounting and operating do not need to be conducted at a narrow opening accommodating the key spring C3, and thus mounting and maintaining processes are greatly simplified. The whole locking structure C can be accommodated in the handle E through the switch axis main body C1, and the key switch C2 and the handle E are integrated accordingly; when the key switch C2 falls into the handle E, the handle E can rotate and be pushed and pulled freely in the folding main frame B; when the key switch C2 is ejected out of the handle hole E1 and simultaneously located in the main frame hole B21 and the directional hole B31, the movement state of the handle E and the folding main frame B can be limited by the key switch C2, the handle E cannot be pushed or pulled or rotated in the folding main frame B, and the first folding main frame body B1 and the second folding main frame body B2 cannot rotate relatively.

According to a preferred scheme for controlling the lock state of the handle E and the net ring connecting piece A, the locking structure C comprises a switch tightening piece C6, a switch spring C7 and a switch pressing plate C8 in the embodiment

One end of the switch spring C7 is connected with the switch tightening piece C6, the other end of the switch spring C7 is connected with the switch pressing plate C8, the switch tightening piece C6, the switch spring C7 and the switch pressing plate C8 are all mounted in the switch axis main body C1, and the switch tightening piece C6 is used for being interlocked with the interlocking mechanism.

Preferably, the switch tightening piece C6, the switch spring C7 and the switch pressing plate C8 are mounted on the front portion of the switch axis main body C1, and the switch spring C7 stretches and retracts in the push-pull direction of the handle E.

On the one hand, the switch axis main body C1 can serve as a shell used for mounting the switch tightening piece C6, the switch spring C7 and the switch pressing plate C8, and on the other hand, the switch axis main body C1 can be matched with the switch tightening piece C6 and be interlocked with the interlocking mechanism, and thus the handle E and the net ring connecting piece A are interlocked. Meanwhile, the switch spring C7 is squeezed by the switch tightening piece C6 and applies force to the switch tightening piece C6 reversely so that the switch tightening piece C6 and the switch axis main body C1 can still tightly lock the interlocking mechanism when the internal folding fish dip net is placed vertically, and the interlocking mechanism is prevented from rotating and disengaging from the switch tightening piece C6 and the switch axis main body C1.

Preferably, the stretching-retracting direction of the key spring C3 is perpendicular to the stretching-retracting direction of the switch spring C7.

Since the key switch C2, the key spring C3 and the spring pressing plate C4 are used for locking and unlocking the handle E and the folding main frame B, the key spring C3 stretches and retracts in the radial direction of the handle E; since the switch tightening piece C6, the switch spring C7 and the switch pressing plate C8 are used for locking and unlocking the handle E and the net ring connecting piece A, the switch spring C7 stretches and retracts in the push-pull direction of the handle E. The two components have independent functions and can be fixed in the handle E through two independently-arranged inner sleeves, however, the two inner sleeves are likely to disengage from the handle E under such circumstance. In the embodiment, the two components are integrated though the switch axis main body C1, and higher strength is achieved compared with the way that the two components are arranged independently; meanwhile, production procedures are simplified, and cost is reduced. Control over the lock state of the handle E and the net ring connecting piece A and control over the lock state of the handle E and the folding main frame B are integrated.

Preferably, an independent baffle C9 is fixedly arranged in the switch axis main body C1, so that control over the lock state of the handle E and the net ring connecting piece A is independent of control over the lock state of the handle E and the folding main frame B, and mutual interference between the connecting structure of the key switch C2, the key spring C3 and the spring pressing plate C4 and the connecting structure of the switch tightening piece C6, the switch spring C7 and the switch pressing plate C8 is avoided.

Correspondingly, in the embodiment, a tightening opening C11 is formed in the end, close to the interlocking mechanism, of the switch axis main body C1, the interlocking mechanism comprises a tightening protrusion A9, the shape of the tightening opening C11 is matched with the shape of the tightening protrusion A9, the tightening opening C11 is used for locking and unlocking the tightening protrusion A9, and when the tightening opening C11 locks the tightening protrusion A9, the tightening protrusion A9 is locked between the tightening opening C11 and the switch tightening piece C6. The shape of the tightening opening C11 and the shape of the tightening protrusion A9 can be designed freely by those skilled in the field according to actual requirements.

Preferably, the tightening opening C11 is formed in the front end of the switch axis main body C1 in the embodiment.

Preferably, the tightening protrusion A9 is fixedly arranged at the rear end of the lock head connection axis A3 in the embodiment.

The tightening protrusion A9 enters the tightening opening C11, then the tightening opening C11 and the tightening protrusion A9 are clamped together by rotating the handle E, and accordingly firm locking can be achieved through the switch tightening piece C6.

Preferably, a tightening protrusion groove is further formed in the front end of the switch axis main body C1. The tightening protrusion groove is formed in the side, close to the switch tightening piece C6, of the switch axis main body C1 and is arranged obliquely relative to the tightening opening C11 in the rotating direction of the handle E. The tightening protrusion A9 is located in the tightening protrusion groove when locked by the tightening opening C11. The tightening protrusion A9 enters the switch axis main body C1 from the tightening opening C11 and falls into the tightening protrusion groove by rotating the handle E, the tightening protrusion A9 is firmly limited in the tightening protrusion groove and cannot rotate freely without human effects, and thus accidental unlocking is avoided.

Preferably, the interior of the handle E is of a hollow structure, the switch axis main body C1 is fixed in the handle E, a seal ring connecting piece C10 is arranged at the end, away from the net ring connecting piece A, of the switch axis main body C1, and an O-shaped waterproof ring C5 is connected to the seal ring connecting piece C10 in a sleeving mode and mounted in the handle E. Since the interior of the handle E is of the hollow structure, large buoyancy force can be generated under the condition that the handle E falls into the water, correspondingly, a gap can be generated on the joint of the switch axis main body C1 and the interior of the handle E, the gap between the switch axis main body C1 and the interior of the handle E can be blocked by connecting the O-shaped waterproof ring C5 to the switch axis main body C1, water is prevented from entering the handle E from the gap between the switch axis main body C1 and the interior of the handle E after the handle E falls into the water, and thus the handle E is prevented from sinking into the water.

Preferably, the O-shaped waterproof ring C5 is selectively made of an elastic material such as rubber.

A groove D3 is formed in the bottom of the net pipe D, the interior of the net pipe D is of a hollow structure D4, and thus the net pipe D is a grooved net pipe in the embodiment.

The net pipe D is generally poor in strength and prone to breaking after being grooved, a baffle plate D5 is formed between the interior of the net pipe D and the groove D3 through the hollow structure D4, high strength of the net pipe D can be kept through the baffle plate D5, the average density of the net pipe D is decreased through the hollow structure D4, the buoyancy force of the net pipe D is increased, and thus the dip net is not prone to sinking even if the dip net falls into the water. The fishnet G can be mounted in the groove D3 and can also completely cover the net pipe D.

Preferably, the fishnet G is mounted in the groove D3 in the embodiment.

Corresponding,ly, an opening is formed in the groove D3 and is close to the folding main frame B. The opening is used as an inlet for the fishnet G to be sleeved into the groove D3. In the prior art, the folding main frame. B needs to be detached when the fishnet G is mounted, and then the net pipe G is sleeved into the groove D3 from the two ends of the net pipe D. In the embodiment, the fishnet G can be sleeved into the groove D3 from the opening so that the fishnet G can be mounted and dismounted without detaching the net ring connecting piece A, and the mounting and dismounting mode of the fishnet G in the prior art is greatly changed.

Preferably, the first net pipe body D1 is a grooved net pipe in the embodiment, a first opening D6 is formed in the first net pipe body D1, and the first opening D6 on the first net pipe body D1 is 1-5 centimeters away from the first folding main frame body B1.

Preferably, the second net pipe body D2 is a grooved net pipe in the embodiment, a second opening D7 is formed in the second net pipe body D2, and the second opening D7 on the second net pipe body D2 is 1-5 centimeters away from the second folding main frame body B2.

If the distance between the opening and the folding main frame B is too large, the fishnet G is not prone to being sleeved into the whole groove D3, and if the distance between the opening and the folding main frame B is too small, the fishnet G is prone to disengaging from the opening. Taking the two problems into consideration, the distance between the opening and the folding main frame B is set to 1-5 centimeters.

Preferably, a hollow structure D4 is arranged in the first net pipe body D1 in the embodiment. A hollow structure D4 is also arranged in the second net pipe body D2.

Preferably, a first upper waterproof plug piece A4 is arranged at the upper end of the hollow structure D4 in the first net pipe body D1, and the first net pipe body D1 is connected with the first net ring connecting piece body A1 through the first upper waterproof plug piece A4. A first lower waterproof plug piece B4 is arranged at the lower end of the hollow structure D4 in the first net pipe body D1, and the first net pipe body D1 is connected with the first folding main frame body B1 through the first lower waterproof plug piece B4.

Preferably, a second upper waterproof plug piece A5 is arranged at the upper end of the hollow structure D4 in the second net pipe body D2, and the second net pipe body D2 is connected with the second net ring connecting piece body A2 through the second upper waterproof plug piece A5. A second lower waterproof plug piece B5 is arranged at the lower end of the hollow structure D4 in the second net pipe body D2, and the second net pipe body D2 is connected with the second folding main frame body B2 through the second lower waterproof plug piece B5.

The first upper waterproof plug piece A4 is fixed to the first net ring connecting piece body A1 through a first upper self-tapping screw A7. The first lower waterproof plug piece B4 is fixed to the first folding main frame body B1 through a first lower self-tapping screw B6.

The second upper waterproof plug piece A5 is fixed to the second net ring connecting piece body A2 through the second upper self-tapping screw A8. The second lower waterproof plug piece B5 is fixed to the second folding main frame body B2 through a second lower self-tapping screw B7.

The first net pipe body D1, the first net ring connecting piece body A1 and the first folding main frame body B1 can be produced integrally, the second net pipe body D2, the second net ring connecting piece body A2 and the second folding main frame body B2 can also be produced integrally, however, by adoption of integral production, cost is high, mold opening is difficult, and strength is poor, and thus the assembling way is adopted.

Since the interior of the net pipe D is of the hollow structure D4, under the condition that the internal folding fish dip net falls into the water, water enters the hollow structure D4 to make the dip net sink into the water; by blocking the hollow structure D4 through the first upper waterproof plug piece A4, the first lower waterproof plug piece B4, the second upper waterproof plug piece A5 and the second lower waterproof plug piece B5, water cannot enter the hollow structure D4 even if the internal folding fish dip net falls into the water, and thus the internal folding fish dip net can float on water permanently.

The internal folding fish dip net in the embodiment can be in four states, namely the folded and collapsed state, the folded and non-collapsed state, the collapsed and non-folded state and the unfolded service state.

In the unfolded service state, the key switch C2 is naturally ejected out of the handle hole E1 under the effect of the key spring C3, and the handle E is pulled to the maximum extent and is in the non-collapsed state. The first net pipe body D1 and the second net pipe body D2 are unfolded to the maximum extent. The main frame hole B21 communicates with the directional hole B31 at the moment, and the key switch C2 penetrates through the handle hole E1, the main frame hole B21 and the directional hole B31 simultaneously. In this way, the first folding main frame body B1 and the second folding main frame body B2 cannot rotate relatively, the first net pipe body D1 and the second net pipe body D2 cannot rotate relatively either, and the handle E cannot rotate or be pushed or pulled in the folding main frame B. At the moment, the overall connection state of the internal folding fish dip net is stable, and the internal folding fish dip net can be used stably.

In the folded and non-collapsed state, the key switch C2 is naturally ejected out of the handle hole E1 under the effect of the key spring C3, and the handle E is partially pushed in (moves towards the interlocking mechanism) relative to the unfolded service state and is in the non-collapsed state. The key switch C2 is not located in the main frame hole B21 or the directional hole B31 at the moment, the first folding main frame body B1 and the second folding main frame body B2 can rotate relatively, and the first net pipe body D1 and the second net pipe body D2 opposite to the first net pipe body D1 can also rotate relatively. However, in the folded and non-collapsed state, the first net pipe body D1 and the second net pipe body D2 are folded in an attached mode. The handle E can also be pushed and pulled or rotate in the folding main frame B.

In the collapsed and non-folded state, the key switch C2 is naturally ejected out of the handle hole E1 under the effect of the key spring C3. The handle E is pushed into to the maximum extent and is in the collapsed state. Correspondingly, the switch tightening piece C6 and the interlocking mechanism are interlocked, and preferably, the tightening protrusion A9 is located in the tightening protrusion groove. The key switch C2 is not located in the main frame hole B21 and the directional hole B31 at the moment, the first folding main frame body B1 and the second folding main frame body B2 can rotate relatively, and the first net pipe body D1 and the second net pipe body D2 opposite to the first net pipe body D1 can also rotate relatively. However, in the collapsed and non-folded state, the first net pipe body D1 and the second net pipe body D2 are in the unfolded state, and the main frame hole B21 communicates with the directional hole B31. The handle E can rotate in the folding main frame B.

In the folded and collapsed state, the key switch C2 is naturally ejected out of the handle hole E1 under the effect of the key spring C3. The handle E is pushed in to the maximum extent and is in the collapsed state. Correspondingly, the switch tightening piece C6 and the interlocking mechanism are interlocked, and preferably, the tightening protrusion A9 is located in the tightening protrusion groove. The key switch C2 is not located in the main frame hole B21 and the directional hole B31 at the moment, the first folding main frame body B1 and the second folding main frame body B2 can rotate relatively, and the first net pipe body D1 and the second net pipe body D2 opposite to the first net pipe body D1 can also rotate relatively. However, in the folded and collapsed state, the first net pipe body D1 and the second net pipe body D2 are folded in an attached mode. The handle E can rotate in the folding main frame B. Preferably, a handlebar E2 is arranged at the lower end of the handle E, and the handlebar E2 abuts against the folding main frame B in the folded and collapsed state. Similarly, a protrusion or a groove is arranged at the front end of the switch axis main body C1, and correspondingly, a groove or a protrusion which is matched with the front end of the switch axis main body C1 is arranged at the front end of the first folding main frame body B1 so that the front end of the switch axis main body C1 can be clamped to the front end of the first folding main frame body B1 in the folded and collapsed state.

Preferably, a hanging decorative plug E3 is arranged at the lower end of the handlebar E2. The handle E can be in a completely-sealed state through the hanging decorative plug E3, and thus water is prevented from flowing into the handle E from the end.

In the unfolded service state, the key switch C2 is pressed to enter the switch axis main body C1, so that the first folding main frame body B1 and the second folding main frame body B2 are not restricted by the key switch C2 any more, restriction of the key switch C2 to the handle E is also eliminated reversely, the first folding main frame body B1 and the second folding main frame body B2 can rotate relatively by pushing in the handle E towards the interlocking mechanism at the moment, and meanwhile, the handle E can be switched from the rotating state in the folding main frame B to the push-pull state.

When the handle E is not pushed to the interlocking mechanism, the first net pipe body D1 or the second net pipe body D2 is rotated at the moment till the first net pipe body D1 and the second net pipe body D2 are folded and collapsed, and thus the internal folding fish dip net can be switched from the unfolded service state to the folded and non-collapsed state.

When the handle E is pushed to the interlocking mechanism, the handle E is rotated to make the tightening protrusion A9 opposite to the tightening opening C11, then the tightening protrusion A9 enters the tightening opening C11 and squeezes the switch tightening piece C6, afterwards, the handle E is rotated till the tightening protrusion A9 falls into the tightening protrusion groove, and thus the switch tightening piece C6 and the interlocking mechanism are interlocked. At the moment, the internal folding fish dip net can be switched from the unfolded service state to the collapsed and non-folded state without rotating the first net pipe body D1 and the second net pipe body D2.

When the internal folding fish dip net is switched from the collapsed and non-folded state to the folded and collapsed state, only the first net pipe body D1 or the second net pipe body D2 needs to be rotated fill the first net pipe body D1 and the second net pipe body D2 are folded in an attached mode.

When the internal folding fish dip net is switched from the folded and non-collapsed state to the folded and collapsed state, only the handle E needs to be pushed till the tightening protrusion A9 is attached to or close to the tightening opening C11, then the handle E is rotated to make the tightening protrusion A9 opposite to the tightening opening C11, afterwards, the tightening protrusion A9 enters the tightening opening C11 and squeezes the switch lightening piece C6, the handle E is rotated finally till the tightening protrusion A9 falls into the tightening protrusion groove, and thus the switch tightening piece C6 and the interlocking mechanism are interlocked.

The above description refers to the process of the internal folding fish dip net from the unfolded service state to the folded and collapsed state, the internal folding fish dip net in the unfolded service state can be switched to the collapsed and non-folded state firstly and then switched to the folded and collapsed state, and the internal folding fish dip net in the unfolded service state can also be switched to the folded and non-collapsed state firstly and then switched to the folded and collapsed state.

When the internal folding fish dip net is switched from the folded and collapsed state to the unfolded service state, the internal folding fish dip net can be switched from the folded and collapsed state to the folded and non-collapsed state firstly and then switched to the unfolded service state. In addition, the internal folding fish dip net can also be switched from the folded and collapsed state to the collapsed and non-folded state firstly and then switched to the unfolded service state. The above process can be operated only by taking reverse operation in the process from the unfolded service state to the folded and collapsed state for reference.

For a clearer illustration, the process of switching the internal folding fish dip net from the folded and collapsed state to the folded and non-collapsed state and then to the unfolded service state is described in the embodiment.

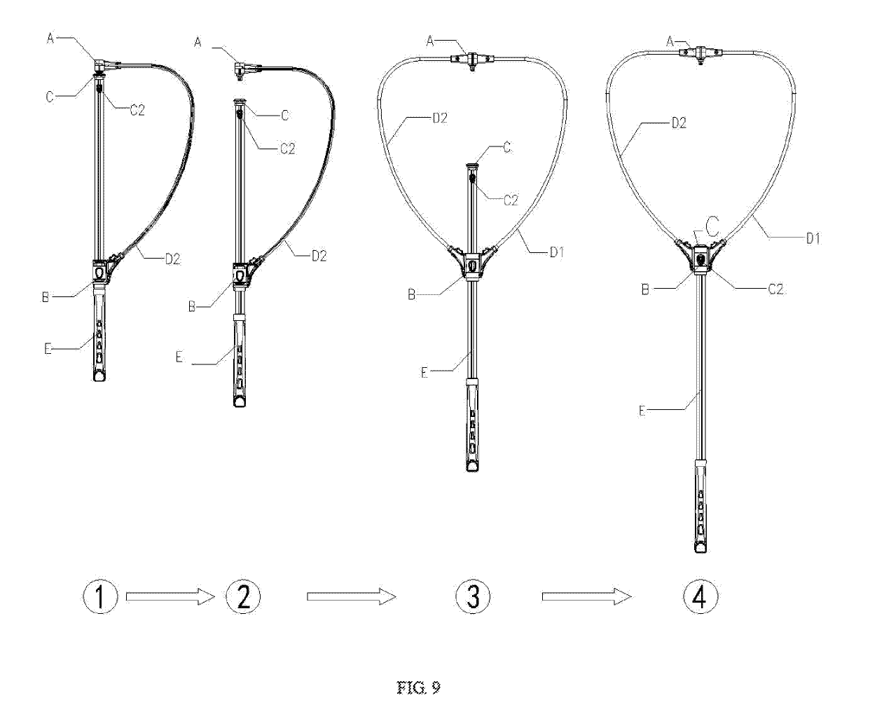

Please see FIG. 9, in the folded and collapsed state, the handle E is rotated firstly till the tightening protrusion A9 is opposite to the tightening opening C11, and then the tightening protrusion A9 is taken out of the tightening opening C11 by pulling out of the handle E (in the direction away from the interlocking mechanism), so that the internal folding fish dip net is switched to the folded and non-collapsed state; afterwards, the first net pipe body D1 and the second net pipe body D2 are unfolded to make the main frame hole B21 communicate with the directional hole B31, finally, the key switch C2 is pressed and the handle E is pulled out at the same time so that the key switch C2 can enter the folding main frame B, the handle E is pulled out to the maximum extent and then rotated till the handle hole E1, the main frame hole B21 and the directional hole B31 communicate with one another, the key switch C2 protrudes out of the main frame hole B21 and the directional hole B31, and thus the internal folding fish dip net is switched to the unfolded service state.

The process of switching the internal folding fish dip net from the folded and collapsed state to the collapsed and non-folded state firstly and then to the unfolded service state is similar to the above process.

In the folded and collapsed state, the first net pipe body D1 and the second net pipe body D2 are unfolded firstly to make the main frame hole B21 communicate with the directional hole B31, and thus the internal folding fish dip net is switched to the collapsed and non-folded state. Then the handle E is rotated till the tightening protrusion A9 is opposite to the tightening opening C11, then the tightening protrusion A9 is taken out of the tightening opening C11 by pulling out of the handle E (in the direction away from the interlocking mechanism), afterwards, the key switch C2 is pressed, the handle E is further pulled out at the same time so that the key switch C2 can enter the folding main frame B, the handle E is pulled out to the maximum extent, then the handle E is rotated till the handle hole E1, the main frame hole B21 and the directional hole B31 communicate with one another, the key switch C2 protrudes out of the main frame hole B21 and the directional hole B31, and thus the internal folding fish dip net is switched to the unfolded service state.

In addition, it should be pointed out that the shapes, tiles and the like of parts and components in the specific embodiments in the description can be different, and the above content in the description is only illustrative description of the structure of the invention. All equivalent changes or simple changes made according to the structure, characteristics and principle of the patent concept of the invention are within the protection scope of the patent of the invention. Various modifications or supplements or similar substitutes which can be made by those skilled in the technical field without deviating from the structure of the invention or exceeding the range defined by the claims all should be within the protection scope of the invention.

What is claimed is:

1. An internal folding fish dip net, comprising a net ring connecting piece, a handle, a folding main frame, a net pipe and a locking structure; wherein the folding main frame comprises a first folding main frame body and a second folding main frame body, the net pipe comprises a first net pipe body and a second net pipe body, the net ring connecting piece comprises a first net ring connecting piece body and a second net ring connecting piece body; wherein the first net pipe body is fixedly connected with the first folding main frame body, the first net ring connecting piece body is fixedly connected with the first net pipe body, the second net pipe body is fixedly connected with the second folding main frame body, the second net ring connecting piece body is fixedly connected with the second net pipe body, the first folding main frame body and the second folding main frame body are rotatably mounted, and the first net ring connecting piece body and the second net ring connecting piece body are rotatably mounted; wherein the locking structure is connected with the handle for controlling the rotating state of the first folding main frame body and the second folding main frame body;
wherein the folding main frame further comprises a directional shaft sleeve, wherein the directional shaft sleeve is fixed in the first folding main frame body, the second folding main frame body is connected to the directional shaft sleeve in a sleeving mode and rotatably mounted on the directional shaft sleeve, and the handle is mounted in the directional shaft sleeve in a push-pull mode; a main frame hole is formed in the second folding main frame body, a directional hole is formed in the directional shaft sleeve, and the main frame hole communicates with the directional hole when the first net pipe body and the second net pipe body are completely stretched; wherein the locking structure limits movement of the handle, the first folding main frame body and the second folding main frame body, when the locking structure is buckled in the main frame hole and the directional hole simultaneously.

2. The internal folding fish dip net according to claim 1, wherein the net ring connecting piece comprises an interlocking mechanism, wherein the interlocking mechanism is connected with the first net ring connecting piece body or the second net ring connecting piece body, wherein the interlocking mechanism interlocks with the locking structure to connect the handle and the net ring connecting piece.

3. The internal folding fish dip net according to claim 2, wherein the interlocking mechanism is a lock head connection axis;
wherein when the first net ring connecting piece body is fixedly connected to the lock head connection axis, the second net ring connecting piece body is rotatably mounted on the lock head connection axis;
wherein when the second net ring connecting piece body is fixedly connected to the lock head connection axis, the first net ring connecting piece body is rotatably mounted on the lock head connection axis.

4. The internal folding fish dip net according to claim 1, wherein the locking structure comprises a switch axis main body, a key switch, a key spring and a spring pressing plate, wherein a first end of the key spring is connected to the spring pressing plate, a second end of the key spring is connected to the key switch, the spring pressing plate is detachably mounted at a bottom of the switch axis main body, the key spring is mounted in the switch axis main body, the switch axis main body is fixed in the handle, a handle hole is formed in the handle, the key switch enters or comes out of the handle hole, and the key switch simultaneously limits movement of the handle, the second folding main frame body and the first folding main frame body when buckled in the handle hole, the main frame hole and the directional hole simultaneously.

5. The internal folding fish dip net according to claim 2, wherein the locking structure comprises a switch axis main body, a switch tightening piece, a switch spring and a switch pressing plate; wherein a first end of the switch spring is connected to the switch tightening piece, a second end of the switch spring is connected to the switch pressing plate; wherein the switch tightening piece, the switch spring and the switch pressing plate are all mounted in the switch axis main body, the switch axis main body is fixedly connected to the handle, wherein the switch lightening piece interlocks with the interlocking mechanism, and the switch spring stretches and retracts in the push-pull direction of the handle.

6. The internal folding fish dip net according to claim 2, wherein the locking structure comprises a switch axis main body, a key switch, a key spring, a spring pressing plate, a switch tightening piece, a switch spring and a switch pressing plate; wherein a first end of the key spring is connected to the spring pressing plate, a second end of the key spring is connected to the key switch; wherein the spring pressing plate is detachably mounted at a bottom of the switch axis main body, the key spring is mounted in the switch axis main body, the switch axis main body is fixed in the handle, a handle hole is formed in the handle, the key switch enters or comes out of the handle hole, and the key switch limits movement of the handle, the first folding main frame body and the second folding main frame body when buckled in the handle hole, the main frame hole and the directional hole simultaneously; wherein a first end of the switch spring is connected to the switch tightening piece, a second end of the switch spring is connected to the switch pressing plate; the switch tightening piece, the switch spring and the switch pressing plate are all mounted in the switch axis main body; wherein the switch tightening piece interlocks with the interlocking mechanism, and the switch spring stretches and retracts in the push-pull direction of the handle; wherein the stretching-retracting direction of the key spring is perpendicular to the stretching-retracting direction of the switch spring.

7. The internal folding fish dip net according to claim 1, wherein a plurality of convex ribs are arranged on the directional shaft sleeve, the directional shaft sleeve is fixed in the first folding main frame body through the plurality of convex ribs, wherein the plurality of convex ribs are made of metal or alloy.

8. The internal folding fish dip net according to claim 1, wherein a groove is formed in a bottom of the net pipe, and the interior of the net pipe is hollow.

9. The internal folding fish dip net according to claim 8, wherein the groove is used for mounting a fishnet, and an opening is formed in the groove; wherein the opening adjoins to the folding main frame.

10. The internal folding fish dip net according to claim 9, wherein the opening is 1-5 centimeters away from the first folding main frame body when the opening is formed in the first pipe net body; wherein the opening is 1-5 centimeters away from the second folding main frame body when the opening is formed in the second net pipe body.

11. The internal folding fish dip net according to claim 8, wherein each of the first net pipe body and the second net pipe body is provided with a hollow structure correspondingly; wherein a plurality of waterproof plug pieces are arranged at the two ends of the hollow structure in the first net pipe body and at the two ends of the hollow structure in the second net pipe body respectively; wherein the first net pipe body is connected to the first net ring connecting piece body and the first folding main frame body through the corresponding waterproof plug pieces, and the second net pipe body is connected to the second net ring connecting piece body and the second folding main frame body through the corresponding waterproof plug pieces.

12. The internal folding fish dip net according to claim 2, wherein the interlocking mechanism and the locking structure are both provided with a plurality of threads, and when the interlocking mechanism and the locking structure are in a locked state, the interlocking mechanism and the locking structure are connected through the threads.

13. The internal folding fish dip net according to claim 5, wherein a tightening opening is formed in the switch axis main body, wherein the interlocking mechanism comprises a tightening protrusion, wherein a shape of the tightening opening is matched with a shape of the tightening protrusion, the tightening opening is used for locking and unlocking the tightening protrusion; wherein when the tightening opening locks the tightening protrusion, the tightening protrusion is locked between the tightening opening and the switch tightening piece.

14. The internal folding fish dip net according to claim 4, wherein the interior of the handle is of a hollow structure, wherein the switch axis main body is fixed inside the handle, a seal ring connecting piece is arranged at an end of the switch axis main body, wherein the end is away from the net ring connecting piece; wherein an O-shaped waterproof ring is connected to the seal ring connecting piece in a sleeving mode and mounted inside the handle.

15. The internal folding fish dip net according to claim 13, wherein the tightening opening is formed in a front end of the switch axis main body, a tightening protrusion groove is further formed in the front end of the switch axis main body, the lightening protrusion groove is arranged obliquely relative to the tightening opening in the rotating direction of the handle; wherein the tightening protrusion is located in the tightening protrusion groove when locked by the tightening opening.

16. A method for using the internal folding fish dip net, the method comprising the following steps:
buckling the locking structure in the main frame hole and the directional hole simultaneously to prevent the first net pipe body and the second net pipe body from rotating relatively and prevent the handle from rotating or being pushed or pulled in the folding frame main body;
unlocking the locking structure to disengage the locking structure from the main frame hole and the directional hole.

17. The method for using the internal folding fish dip net according to claim 16, further comprising a step of pushing the handle to make the locking structure and the interlocking mechanism interlock after the locking structure disengages from the main frame hole and the directional hole, thereby the handle and the net ring connecting piece are interlocked.

18. The method for using the internal folding fish dip net according to claim 17, further comprising a step of pushing the handle to make the tightening opening opposite to the tightening protrusion, wherein the tightening protrusion enters the tightening opening, thereby the switch tightening piece is squeezed accordingly, and
rotating the tightening protrusion to buckle in the tightening opening.

19. The method for using the internal folding fish dip net according to claim 18, further comprising a step of rotating the tightening protrusion to fall into the tightening protrusion groove after the tightening protrusion enters the tightening opening, wherein the tightening protrusion groove is used for limiting rotation of the tightening protrusion.

20. The method for using the internal folding fish dip net according to any of claim 16, further comprising a plurality of steps of:
pressing the key switch to fall into the handle hole when the key switch is buckled in the handle hole, the main frame hole and the directional hole simultaneously, thereby to make the handle capable of rotating or being pushed and pulled in the folding main frame;
unfolding the first net pipe body and the second net pipe body to make the main frame hole communicate with the directional hole when the key switch disengages from the main frame hole and the directional hole; pressing the key switch, then pushing and pulling or rotating the handle is till the key switch is buckled in the handle hole, the main frame hole and the directional hole simultaneously, thereby the rotation of the first net pipe body and the second net pipe body is limited, and push-pull and rotation of the handle are limited at the same time.
